(19) United States
(12) Patent Application Publication
(10) Pub. No.: US 2014/0040819 A1
(43) Pub. Date: Feb. 6, 2014

(54) METHODS AND SYSTEMS FOR MANAGING THE PRESENTATION OF WINDOWS ON A DISPLAY DEVICE

(71) Applicant: Christopher J. Duffy, Sunnyvale, CA (US)

(72) Inventor: Christopher J. Duffy, Sunnyvale, CA (US)

(73) Assignee: Adobe Systems Incorporated, San Jose, CA (US)

(21) Appl. No.: 13/229,001

(22) Filed: Sep. 9, 2011

(51) Int. Cl. G06F 3/048

(52) U.S. Cl. 715/789; 715/799; 715/798

(57) ABSTRACT

Techniques for sizing, positioning and generally managing the display of windows are described herein. Consistent with some embodiments, a group of windows are assigned a position to form an ordered list, or sequence, of windows. The windows are then positioned and sized, based at least in part on their position in the sequence, and presented in accordance with a window layout that specifies that the first window in the sequence is to be positioned prominently as a primary window. Upon detecting a user-input event, the windows are reordered according to an ordering rule, and then presented again in the window layout, sized and placed in accordance with their position in the reordered sequence.

### TECHNICAL FIELD

The present disclosure generally relates to graphical user interfaces. More specifically, the present disclosure relates to methods, systems and computer program products for systematically presenting a display of windows using proportional sizing and placement techniques.

### BACKGROUND

In the context of computing, a “window” is a graphical user interface element that is typically in the shape of a rectangle and is used to display the output of, and allow input to, one or more processes. A window-based computer operating system typically has what is referred to as a “windowing system” to provide a basic level of support for graphics hardware and cursor control devices (e.g., such as computer mice, track pads, keyboards, etc.). Typically, a windowing system will have, or operate in conjunction with, what is referred to as a “window manager” that provides the basic functionality for controlling the placement and appearance of windows, as well as other basic window-related functionality.

Many advances in different areas of computing technology, such as multi-core processors, multi-processor systems, multi-display systems, and so forth, have improved the ability of computers to support users with multi-tasking. For instance, a modern desktop computer typically allows a user to have several applications executing and open simultaneously, thereby allowing the user to switch between the several applications to perform a variety of tasks. Despite the various technical advances, the basic functionality provided by window managers has changed very little. Specifically, modern window managers provide little functionality, if any, which assists users in automating any aspect of the process of switching between the various windows of different executing applications while performing a variety of related tasks. Typically, when simultaneously working with multiple applications, the user must manually manage a group of windows, for example, by manually opening, closing, repositioning and resizing the windows as is necessary to bring the correct window or windows into focus for performing a particular task. This can be a frustrating and time consuming task.

### DESCRIPTION OF THE DRAWINGS

Some embodiments of the invention are illustrated by way of example and not limitation in the figures of the accompanying drawings, in which:

FIG. 1 is a block diagram illustrating an example user interface in which six windows are presented, arranged according to a Fibonacci progression, consistent with some embodiments of the invention;

FIG. 2 is a block diagram illustrating the example user interface presented in FIG. 1 after a user has selected a new window to be the primary window, when the ordering rule for ordering the windows is based on a most-recently-used algorithm, consistent with some embodiments of the invention;

FIG. 3 is a block diagram illustrating the example user interface presented in FIG. 1 after a user has selected a new window as the primary window, when the ordering rule for ordering the windows is based on a most-frequently-used algorithm, consistent with some embodiments of the invention;

FIG. 4 is a block diagram illustrating the example user interface presented in FIG. 1 after a user has selected a new window as the primary window, when the ordering rule for ordering the windows is based on a simple cycling algorithm, consistent with some embodiments of the invention;

FIG. 5 is a block diagram illustrating the example user interface presented in FIG. 1 after a user has selected a secondary window for viewing side-by-side with the primary window, consistent with some embodiments of the invention;

FIG. 6 is a block diagram illustrating an example of a user interface for a portion of a secondary window and showing several graphical icons or buttons for changing a current view of a window layout, according to some embodiments of the invention;

FIG. 7 is a functional block diagram of a computing device with an operating system that includes a window manager module, consistent with some embodiments of the invention;

FIG. 8 is a functional block diagram of a computing device on which an application is executing, and the application includes a window management module consistent with some embodiments of the invention;

FIG. 9 is a flow diagram illustrating an example method for managing the presentation of a group of windows, according to some embodiments of the invention; and

FIG. 10 is a block diagram of a machine in the form of a computing device within which a set of instructions, for causing the machine to perform any one or more of the methodologies discussed herein, may be executed.

### DETAILED DESCRIPTION

The present disclosure describes methods, systems, and computer program products, which individually provide functionality for managing a group of windows on a display device. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Described herein are techniques, for implementation in software, hardware, or a combination thereof, for managing the presentation of multiple windows on a display device. Using a window-based device on which an embodiment of the invention has been implemented, a user can, with minimal manual user-input, very quickly and easily manipulate a group of windows to modify how the windows are presented in a window layout. This is particularly advantageous when a user is working with several applications, each with one or more of its own windows, and the user needs to switch between the various windows to perform various tasks.

Consistent with some embodiments, a first window will be designated as a primary window in a window layout. As described in greater detail below, the selection of the primary window and the ordering of all additional windows to form a sequence of windows are performed in accordance with an ordering rule. At least with some embodiments, the primary window, representing the first window in the sequence of windows, will be the largest window in the window layout. Each additional window, referred to herein as secondary windows, is sized proportionately smaller than the window that precedes it in the sequence. As such, the size of any particular window presented in the window layout depends first on the total size of the display, or the portion of the display selected for presentation of the window layout, and then on the respective window's position in the sequence of windows. As described below, with some embodiments, the position of each window in the sequence will also affect the position or placement of the window in the window layout.

Consistent with some embodiments, the proportion of width to height for each window presented in the window layout is the same. The width-to-height ratio may be selected based on the overall dimensions or aspect ratio of the display on which the window layout is being presented, or the dimensions of a particular portion of the display that is selected for presentation of the window layout. For example, a default ratio of 1.617 might be selected for a display of a mobile device, whereas a default ratio of 2.888 might be selected for a television display, and a default ratio of 1.333 might be selected for a computer monitor display. Naturally, other ratios are possible and entirely consistent with different embodiments of the invention.

After determining the size of the primary window based on the size of the display, each successive secondary window in the sequence is sized based on a sizing ratio. For instance, with some embodiments, the size of each successive window is determined with a sizing ratio of 1.617 (what some mathematicians refer to as the “golden ratio.”) This particular ratio provides an optimal fit for a group of windows when placing the windows in the window layout. Although the present invention is not dependent upon any single window layout scheme, in one particular embodiment, the windows are arranged such that, if one was to draw an are connecting opposite corners of each window, the result would be what is referred to as a golden spiral, or an approximation of a golden spiral, referred to as a Fibonacci spiral.

After the windows are presented in a window layout, a user can very easily and quickly manipulate the size and position of certain windows in the window layout by providing various user input to invoke various window management operations. For example, with some embodiments, by operating a particular user control (e.g., computer mouse, keyboard, track pad, voice command, etc.) a user can select any one of the secondary windows to replace the primary window. The resulting order of the windows will generally be dependent upon the particular ordering rule that is associated with the group of windows. For example, if the ordering rule is based on a most-recently-used algorithm, the selected secondary window becomes the primary window, and the old primary window is simply demoted one position in the sequence, and thus the window layout. In addition to selecting a new primary window, with some embodiments a user can issue a command to view any window in a full-screen window layout. Similarly, a user can issue a command to view any secondary window side-by-side with the current primary window. Of course, other window layouts may be possible and consistent with the invention.

Consistent with some embodiments, when a group of windows is first being positioned or placed in a window layout, the initial sequence of the windows may be established or determined based on a default ordering rule, or a specific ordering rule that has been selected by the user. Similarly, each time the window order changes as a result of a user selecting a new primary window, an ordering rule is used to determine the new order of the window sequence, and thus the position of the windows in the window layout. A few examples of the types of ordering rules that might be implemented for use with the system include, but are certainly not limited to: most-recently-used, most-frequently-used, and simple cycling, among others. With the most-recently-used ordering rule, the order of the windows is determined based on how recently each window was last used, or was in focus—that is, selected as the current window to receive user input. Accordingly, if each letter in the following sequence, (A, B, C, D, E, F), represents an individual window, with the first window, “A”, being the primary window, when a user selects a new window, “D”, to be the primary window, with the most-recently-used ordering rule, the resulting new window sequence will be as follows, (D, A, B, C, E, F). Because window “A” was the previously selected primary window, it is demoted one position in the sequence when the user selects window “D” as the new primary window.

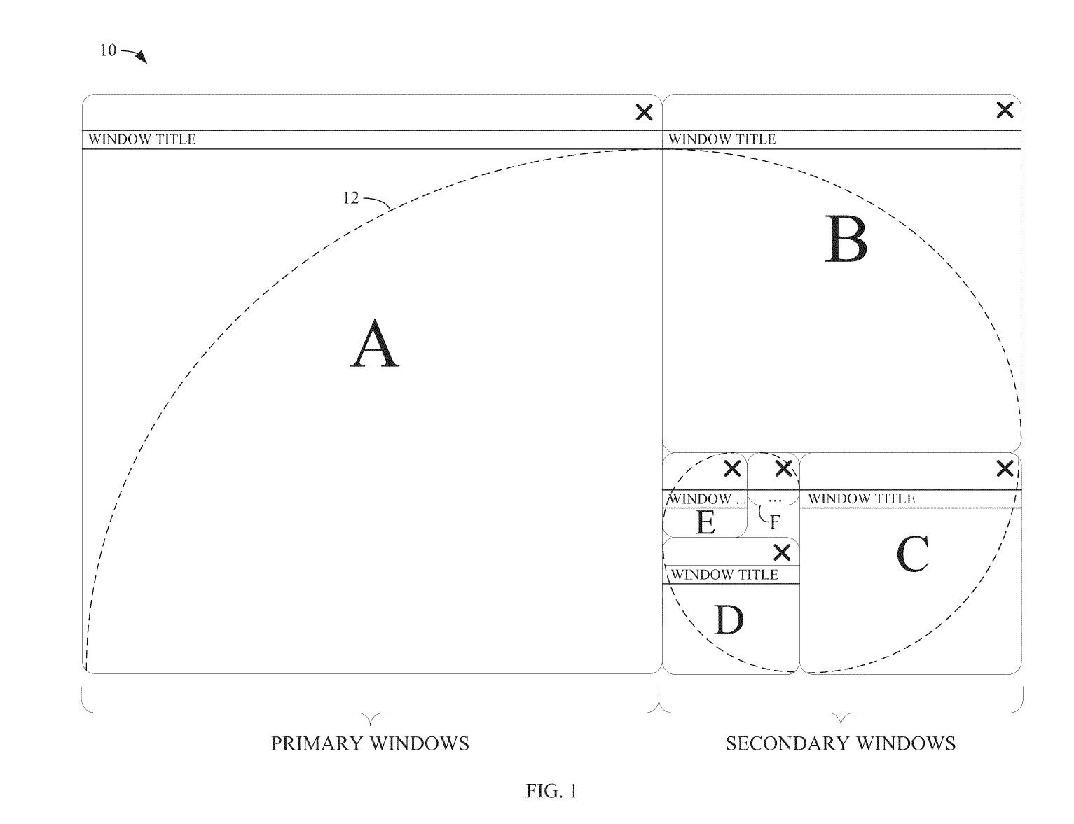

With some embodiments, many of the various window characteristics and behaviors described herein are configurable by a user. For instance, with some embodiments, a user can specify which windows are to be included in a group of windows, for example, by associating applications with a group of windows. As such, a user may specify various different groups of windows for performing different tasks, and then modify the behavior of the windows to fit the tasks. For instance, a user may specify a particular positioning or order for the windows when the windows are first presented in the window layout, as well as a particular ordering rule that is to be used to order the group of windows as the user interacts with the windows by selecting different primary windows, and so forth. A user may configure a maximum number of windows to show in a particular window layout. In addition, a user may specify how those windows that exceed the maximum number of windows for presentation in a window layout are to be alternatively represented. For example, if a window layout has been designated to show no more than six windows, if a particular grouping of windows includes ten windows, the seventh, eighth and ninth windows in the sequence may be shown as minimized icons, in a sidebar, or in some other graphical user interface element. With some embodiments, a user can configure how various window layouts behave when the computing device with which the windows are being presented has more than one display device. For example, with some embodiments, a multi-display window layout may position a first primary window in a full screen view, occupying all or most of the display space of a first display, and then arrange the secondary windows in a spiralling fashion (as shown in FIG. 1) on the second device. Of course, other multi-display window layouts are possible.

Although generally described and presented herein as being applicable to general purpose, window-based computers, skilled artisans will recognize that the inventive subject matter set forth herein is applicable to a wide variety of devices and systems having user interfaces displayed on a display device. For example, in addition to general purpose computers, such as desktops, laptops, notebooks, and so forth, the principles of the inventive subject matter are equally applicable to mobile computing devices, such as tablet computers, mobile phones, personal digital assistants, portable media players, global positioning system devices, game playing devices, and others. Additionally, the inventive subject matter may be applied to other, less mobile devices with graphical user interfaces, including set-top boxes and televisions. Other details of the inventive subject matter will be apparent from the description of the figures that follows.

FIG. 1 is a block diagram illustrating an example user interface 10 in which six windows are presented, arranged according to a Fibonacci progression, consistent with some embodiments of the invention. The user interface presented in FIG. 1 is not meant to limit the scope of the present invention, but instead is presented as one example of many possible window layouts that are consistent with various embodiments of the invention. As illustrated in FIG. 1, the largest window with reference letter “A” is referred to herein as the primary window. Each successive window, including the windows with reference letters, “B”, “C”, “D”, “E”, and “F”, is referred to as a secondary window. The window with reference letter “B” is sized in proportion to the primary window with reference letter “A”, using a sizing ratio. For instance, in this example, the sizing ratio is 1.617. Accordingly, each successive secondary window is sized, using the sizing ratio 1.617, to be proportionately smaller than the window that precedes it in the sequence. Once the size for each window is determined, the windows are then positioned such that a curve connecting opposite corners of the windows forms a spiral (e.g., a Fibonacci spiral), such as the dotted-line spiral with reference number 12 in FIG. 1. By positioning the windows as shown in FIG. 1, the window layout is optimal in the sense that it maximizes, or nearly maximizes, the use of available display space. The small space immediately below the window with reference letter “F” could be occupied by a seventh window, or the window with reference letter “F” could be increased in height to match the height of the window with reference letter “E”.

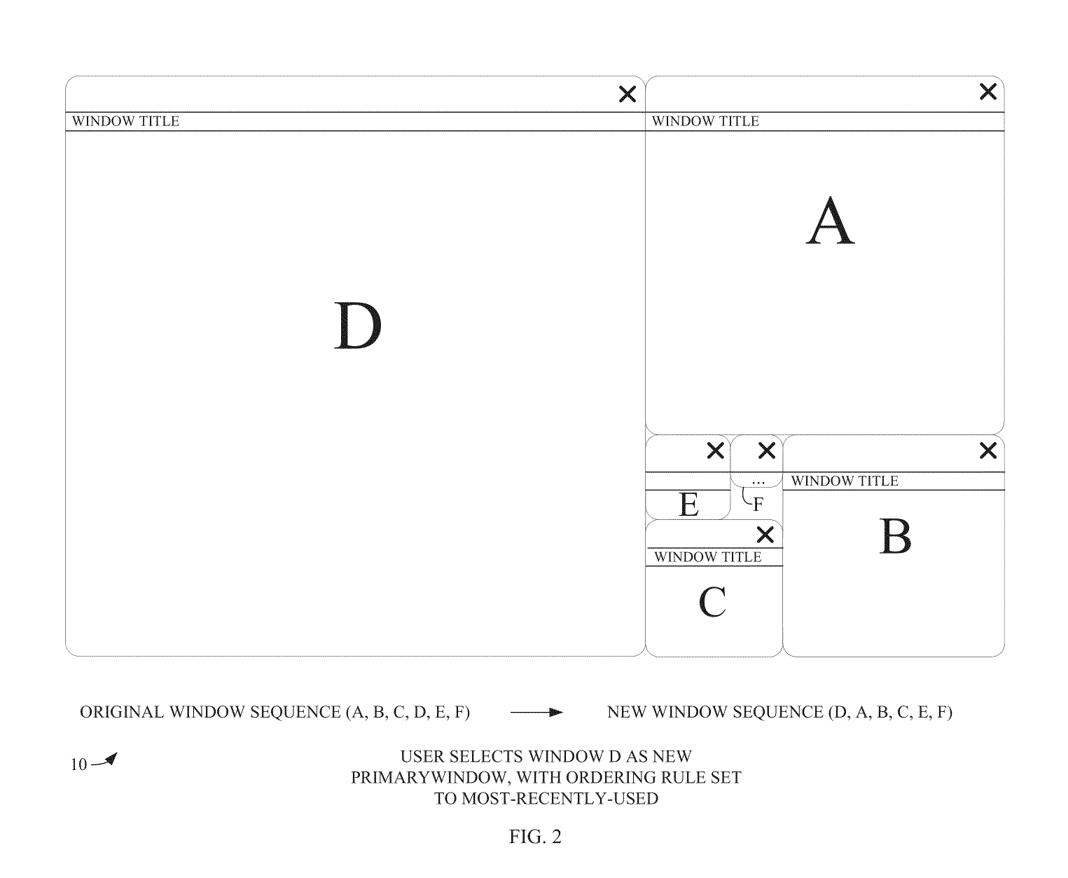

When the windows are first being positioned according to the window layout, the windows may be positioned in an order that is specifically established by the user. For instance, the user may specifically indicate that the windows in a particular group, when first presented in the window layout, are to have a particular order, such as (A, B, C, D, E, F). Alternatively, the windows may be initially positioned based on some default order, or, based on an ordering rule, or based on how the windows were last positioned in the window layout. In addition to affecting the order or position of the windows when first presented, ordering rules also affect how the windows are repositioned, for example, when the user selects a new window to be the primary window. Some example ordering rules are discussed below in connection with the descriptions of FIGS. 2, 3 and 4.

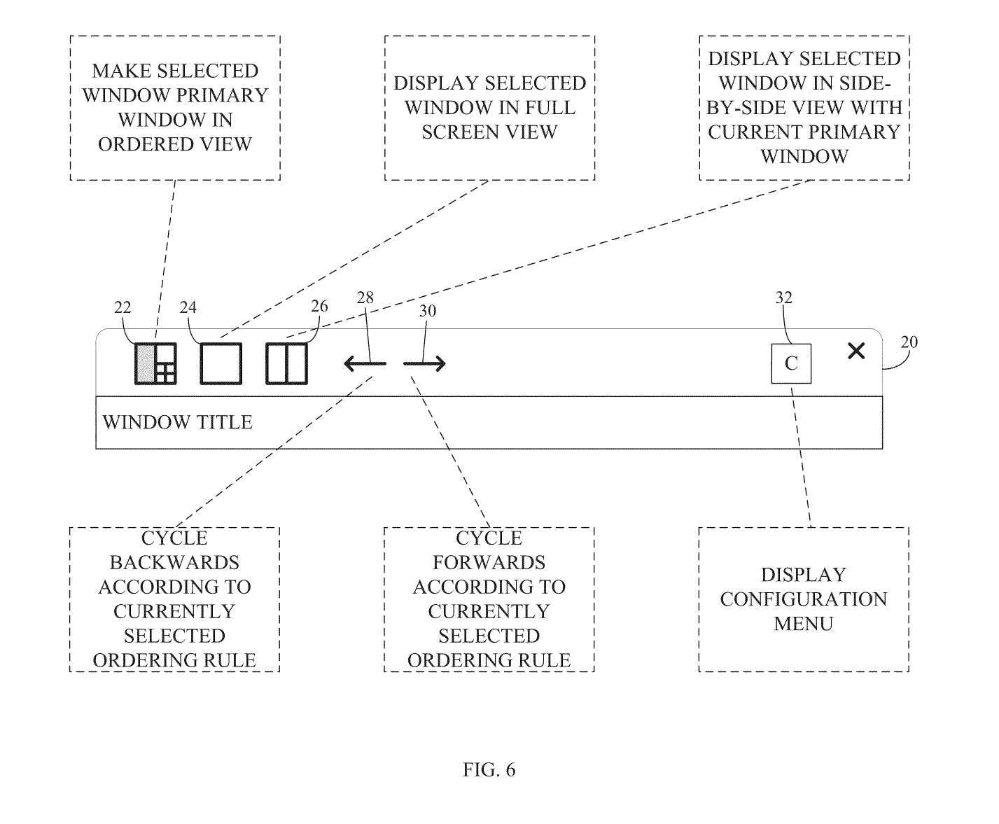

FIG. 2 is a block diagram illustrating the example user interface 10 presented in FIG. 1 after a user has selected a new window to be the primary window, when the ordering rule for ordering the windows is based on a most-recently-used algorithm, consistent with some embodiments of the invention. As illustrated in FIG. 2, the window layout is, in essence, identical to the window layout presented in FIG. 1. Only the order of the windows has changed. For example, when a user issues a command, and the window manager module that is managing the windows detects the user-input event, the order of the windows will be changed in accordance with the particular user-issued command (and detected event). In this particular example, the user has selected to have the window with reference letter “D” become the primary window. As set forth in connection with the description of FIG. 6, there are an almost endless number of ways that a user might issue a command (e.g., to change the primary window to the window with reference letter “D”) that is detectable as an event by the window manager module. One way for a user to issue such a command is by selecting a button or graphical icon located on the top portion of a secondary window. For instance, as illustrated in FIG. 6, the button or icon with reference number 22, when selected, will cause the secondary window on which the button appears to become the new primary window. As shown in FIG. 2, when the user selects the window with reference letter “D” to become the new primary window, the windows are repositioned in accordance with an ordering rule based on a most-recently-used algorithm. As such, the old primary window (i.e., the window with reference letter “A”), which represents the most recently used window, is demoted one position and appears as the second largest window just to the right of the primary window, in the example user interface of FIG. 2. The placement and size of the windows with reference letters “B” and “C” are also changed, consistent with the ordering rule.

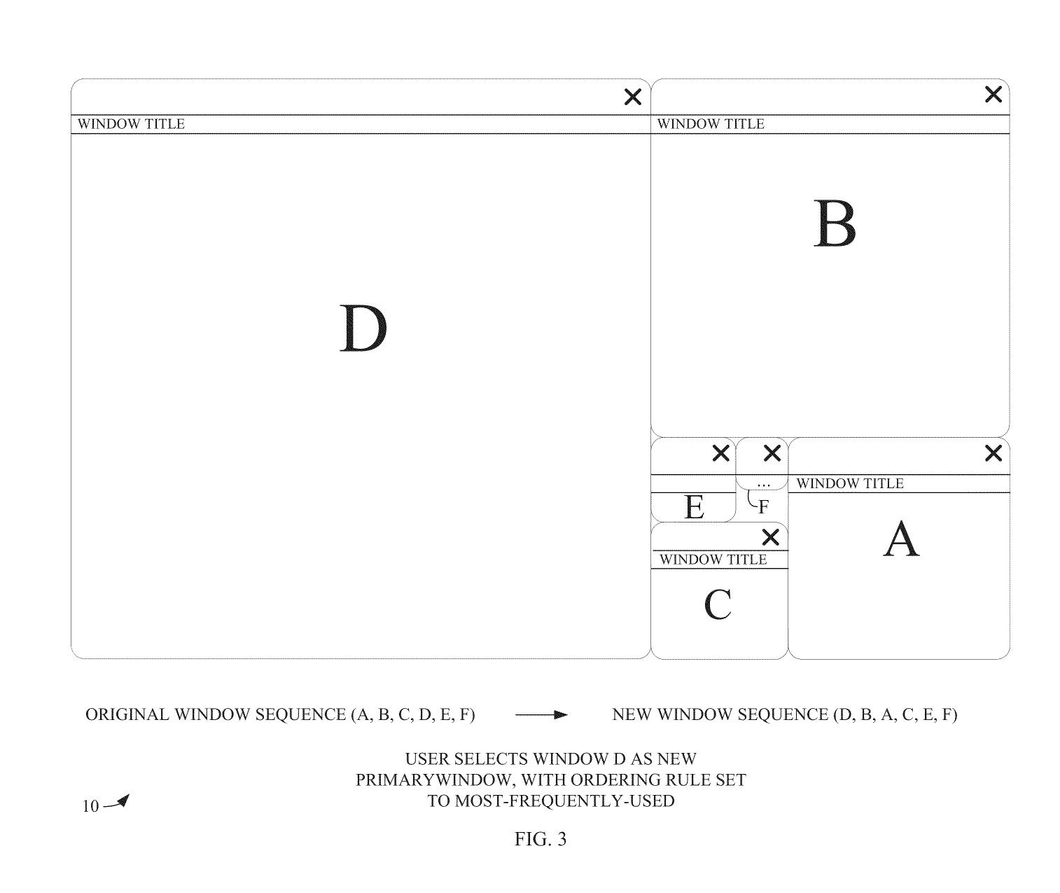

FIG. 3 is a block diagram illustrating the example user interface presented in FIG. 1 after a user has selected a new window as the primary window, when the ordering rule for ordering the windows is based on a most-frequently-used algorithm, consistent with some embodiments of the invention. As illustrated in FIG. 3, a user has selected to have the window with reference letter “D” become the new primary window. This might be achieved by selecting a graphical button or icon associated with the selected window, such as the button or icon with reference number 22 in FIG. 6. As shown in FIG. 3, selection of the window with reference letter “D” as the primary window causes the original window sequence, (A, B, C, D, E, F) to be reordered as, (D, B, A, C, E, F). In this example, the ordering rule is based on a most-frequently-used algorithm. Accordingly, the old primary window (i.e., the window with reference letter “A”) is repositioned between the window with reference letter “B” and the window with reference letter “C”, indicating that, under the metric used to measure frequency of use, the window with reference letter “A” has been more frequently used than window “C”, but less frequently used than window “B”.

In various embodiments, different metrics or measures of use may be used with the most-frequently-used ordering rule. For instance, with some embodiments, the duration of time that a window is in focus may be measured and used as the metric for frequency of window use. As such, a window that is in focus more frequently (e.g., for a longer duration of time) than another window will have a position ahead of the other window in the sequence of windows. In some embodiments, in addition to measuring the time that a window is in focus, the number of actual user interactions (e.g., the number of times a user provides input to a window) may be detected, and taken into consideration when deriving a metric meant to represent the frequency of use of a window. In some embodiments, the metric or measure for the frequency of use may be based on the duration of time that a window is open, as opposed to closed. Of course, with some embodiments, the metric may be a combination of any of the aforementioned metrics. With some embodiments, the frequency of use metric may automatically be reset to zero when a particular window session is first initiated. In other embodiments, the frequency of use metric may be maintained across different user sessions. In any case, a window manager module, or some other component, will monitor the use of each window and store a value representing the frequency of use, such that, when repositioning the windows in accordance with the most-frequently-used ordering rule, the windows are ordered, and thus positioned, in accordance with their respective use metric.

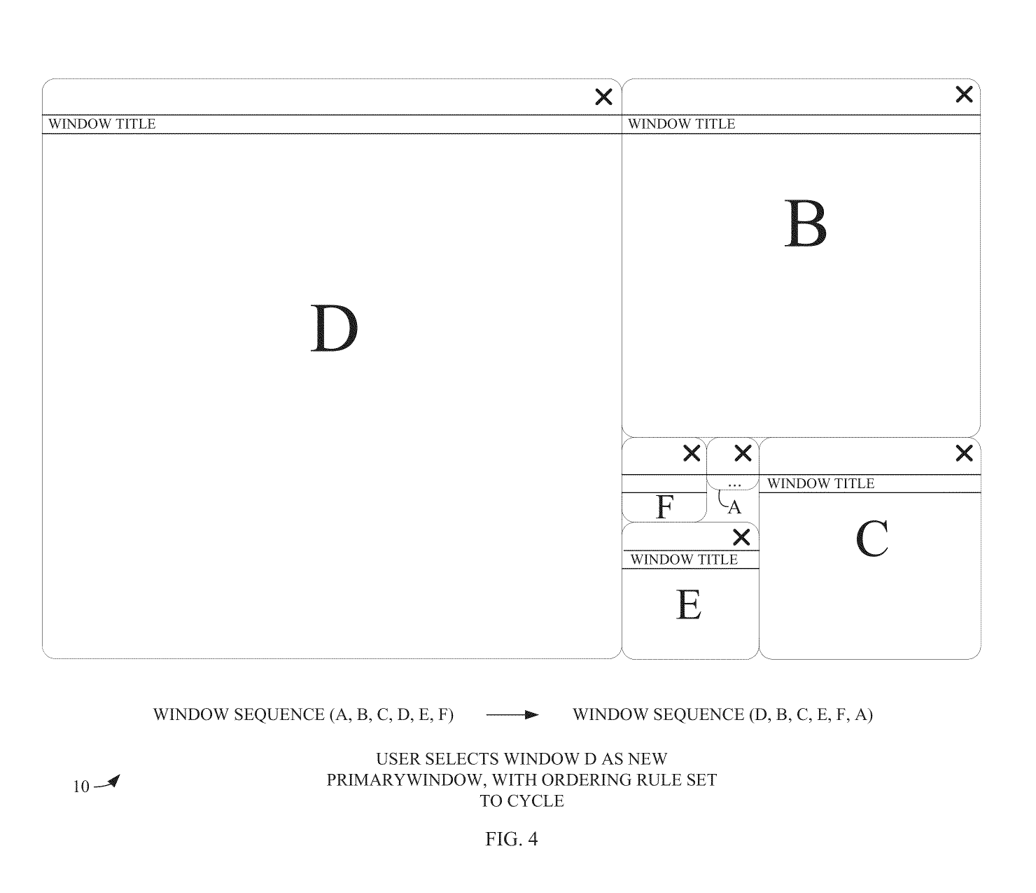

FIG. 4 is a block diagram illustrating the example user interface 10 presented in FIG. 1 after a user has selected a new window as the primary window, when the ordering rule for ordering the windows is based on a simple cycling algorithm, consistent with some embodiments of the invention. Consistent with the ordering rule referred to as the cycling ordering rule, when a user selects a new primary window, the current primary window is simply positioned last in the sequence. Accordingly, as illustrated in FIG. 4, when the user selects the window with reference letter “D” to be the new primary window, the old primary window with reference letter “A” is positioned last in the sequence, and thus shown as the smallest window in the example user interface 10 of FIG. 4.

While FIGS. 2, 3 and 4 illustrate several specific examples of ordering rules by which the order (and therefore placement) of windows may be determined, many other ordering rules might also be implemented consistent with various embodiments of the invention. For example, with some embodiments, an ordering rule referred to herein as the highest priority ordering rule might be used. Using the highest priority ordering rule, the windows are arranged in a sequence in accordance with some value (e.g., number, letter, etc.), representing a priority value, assigned to each window. Accordingly, the window with the highest priority value is positioned first in the sequence, and thus placed in the primary window position in the window layout. When a user closes, minimizes, or otherwise dismisses the primary window, the window with the next highest priority value is promoted to be the primary window. With some embodiments, the windows may be assigned priority values by a user, such that the priority values are static, and do not change, unless a user modifies or changes the priority value assigned to a particular window. However, with some embodiments, the priority values assigned to the various windows in a group of windows might be algorithmically and dynamically determined. Accordingly, various events and conditions, when detected by a window manager, or some other software component, may cause the priority values assigned to the windows to change. The nature and type of events and conditions on which the priority values depend might vary greatly. For instance, with some embodiments, a window associated with a software process that is in need of user-input might be temporarily promoted (e.g., by increasing its priority value), thereby causing the window to be positioned in the window layout more prominently, and bringing the window (and the need for user input) to the user's attention. Similarly, if a window is associated with a software process that has currently received new information, and thus the window is presenting new information, the priority value of that window might be increased. For example, if a window is associated with an e-mail program, or some other messaging program, when new emails or messages arrive, the priority value of the window might be increased, causing the window to be placed more prominently in the window layout. Of course, a wide variety of other system events and conditions might be considered, and ultimately affect the priority values of various windows.

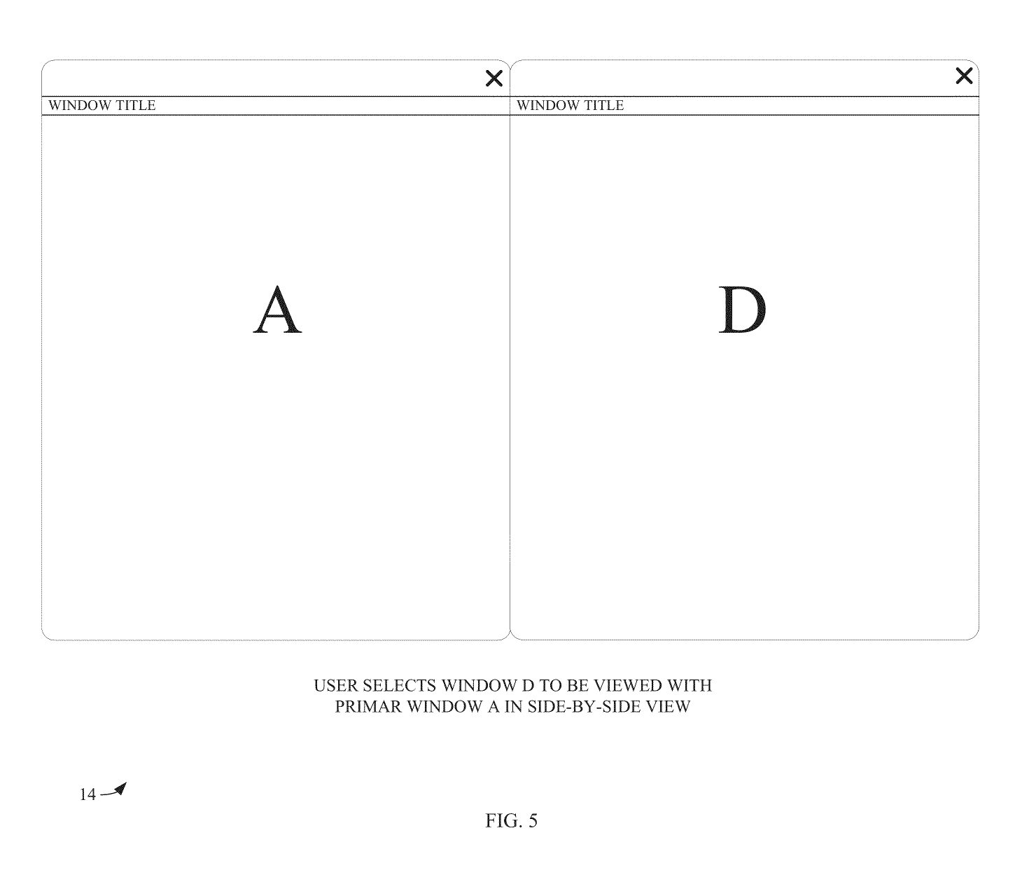

FIG. 5 is a block diagram illustrating an example user interface 10, such as that presented in FIG. 1, after a user has selected a secondary window for viewing side-by-side with the primary window, consistent with some embodiments of the invention. With some embodiments, when a user is viewing a window layout, such as that illustrated in FIG. 1, the user can issue a command to have one of the secondary windows presented in a side-by-side view with the currently selected primary window. For example, by selecting a graphical button or icon, such as the button or icon with reference number 26 in FIG. 6, the window layout will change to a side-by-side view, such as that shown in FIG. 5. In this example, a user has selected to view window “D” side-by-side with the primary window with reference letter “A”.

FIG. 6 is a block diagram illustrating an example of a user interface for a portion of a secondary window and showing several graphical icons or buttons for changing a current view of a window display, according to some embodiments of the invention. The inventive subject matter described herein is generally independent of any particular user input mechanisms. For instance, with various embodiments of the invention, to invoke a particular window operation a user might initiate a command by using a keyboard, a computer mouse, a track pad, a voice command, a touch screen display, a camera or other gesture-sensing component, or just about any other known, or yet-to-be developed user-input mechanism. As such, any number and type of user input mechanism may be used by a user to generate a user-input event, which, when detected and processed by a window manager module, can cause any of the window operations described herein. Accordingly, the particular user interface buttons or icons shown in FIG. 6 are presented here simply as an example, and are by no means meant to limit the scope of the presently claimed subject matter.

In FIG. 6, the top 20 (e.g., header portion) of a secondary window is shown to include a variety of graphical buttons or icons, referred to herein as control buttons. Each control button may be selectable, for example, using a user input mechanism, such as a computer mouse, or touch screen display, and so forth. The particular operation of some of the control buttons will depend on the ordering rule that is in effect for the group of windows, of which the particular secondary window is a member. For example, the control button with reference number 22, when activated or selected, will make the secondary window in which the control button appears the new primary window. For example, assuming the control button with reference number 22 appears in the header portion of the window with reference letter “D” in FIG. 1, selection of the control button 22 will result in the window with reference letter “D” becoming the new primary window. The remaining windows would then be repositioned in accordance with the particular ordering rule that is associated with and active for the group of windows.

The control button with reference number 24, when selected or otherwise invoked, will cause the secondary window 20 in which the control button appears to be displayed in a full screen view. This control button 24, or one similar to it, might also be displayed in the header of the primary window, enabling a user to bring the primary window to a full screen view.

The control button with reference number 26 enables a user to display the selected secondary window in a side-by-side view with the currently displayed primary window. For instance, assuming that the header 20 of the secondary window shown in FIG. 6 represents the window with reference letter “D” in FIG. 1, selection of the control button 26 in the header of window “D” will cause the window layout to change to a side-by-side view, such as that illustrated in FIG. 5.

With some embodiments, one or more control buttons, such as those with reference numbers 28 and 30, may be presented to enable the user to simply cycle through the sequence of windows, either backwards or forwards. For instance, assuming a current window layout consistent with that presented in FIG. 1, selecting the control button with reference number 28, would cause the window sequence to change from, (A, B, C, D, E, F) to (B, C, D, E, F, A). Similarly, selecting the control button with reference number 30 would cause the window sequence to change from (A, B, C, D, E, F) to (F, A, B, C, D, E). Of course, the position of the windows in the window layout would also be effected.

Finally, with some embodiments, a control button 32 may be presented that, when invoked, presents the user with various configuration options and settings. By changing the configuration settings, the user can change the ordering rule, the maximum number of windows to be presented in a given window layout, and a wide variety of other configurable behaviours and functions.

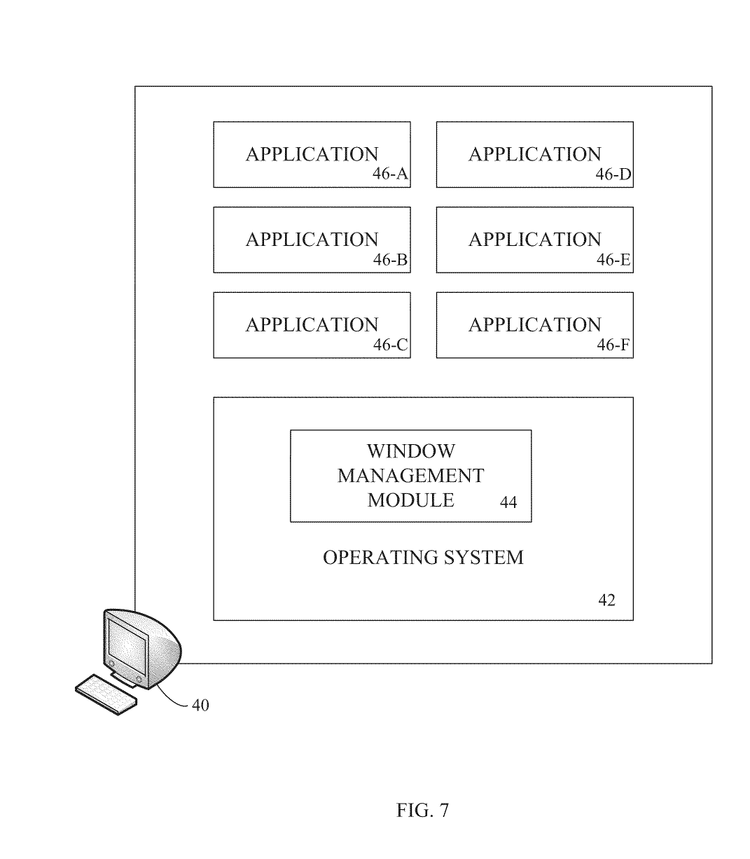

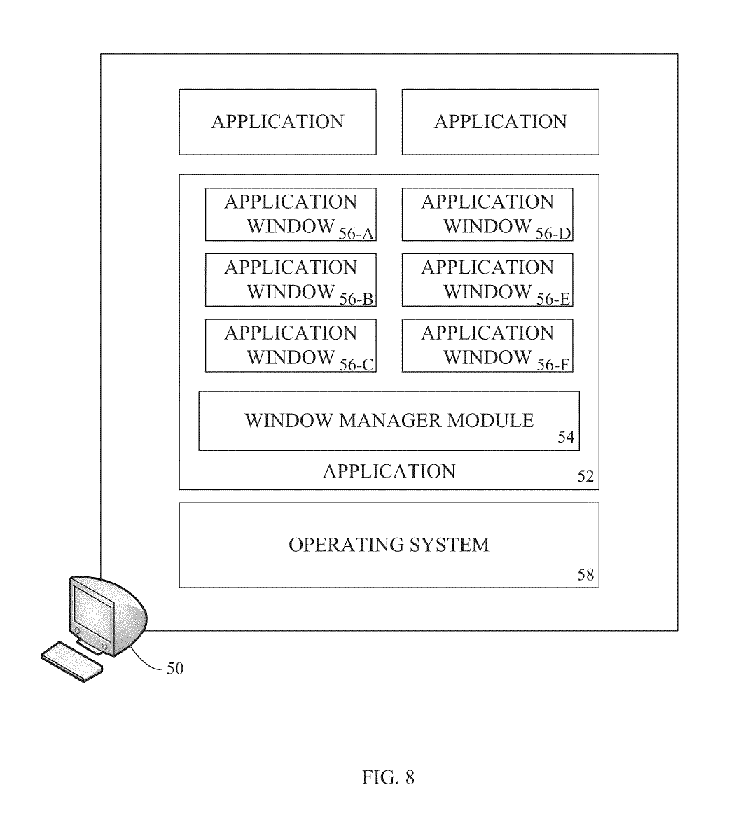

FIG. 7 is a functional block diagram of a computing device 10 with an operating system 42 that includes a window manager module 44, consistent with some embodiments of the invention. As illustrated in FIG. 7, the computing device 40 with which an embodiment of the invention might be implemented includes an operating system 42 that has a window management module 44. In addition, resident in memory of the computing device 40 are several applications 46-A though 46-F. Accordingly, with some embodiments, the various window operations and functionality described herein are carried out by a window management module 44 that is either an operating system component, or is configured to be tightly integrated, and operate in conjunction, with the operating system 42. As illustrated in FIG. 8, with some alternative embodiments, the window manager module 44 may be an application level component.

FIG. 8 is a functional block diagram of a computing device 50 on which an application 52 is executing, and the application includes a window manager module 54 consistent with some embodiments of the invention. As shown in FIG. 8, the window manager module 54 provides the various window operations and functionality described herein, for managing windows of applications, such as 56-A through 56-E in FIG. 8. As such, the window manager module in FIG. 8 is not part of the operating system 58, but will operate by interacting with the operating system 58. With some embodiments, the window manager module 54 may manage only those windows associated with a specific application, or group of applications. For instance, in one embodiment, the application 52 might be a content rendering application, such as a web browser application, and the window manager module 54 may provide window management functionality only for the respective windows of the web browser application. In other embodiments, the application 52 could be a text editor application, a document previewing application, an integrated development environment for developing software applications, or really any other type of application. With some embodiments, the window manager module 54 may be an application that is not associated with any particular application, and manages windows for various different types of applications.

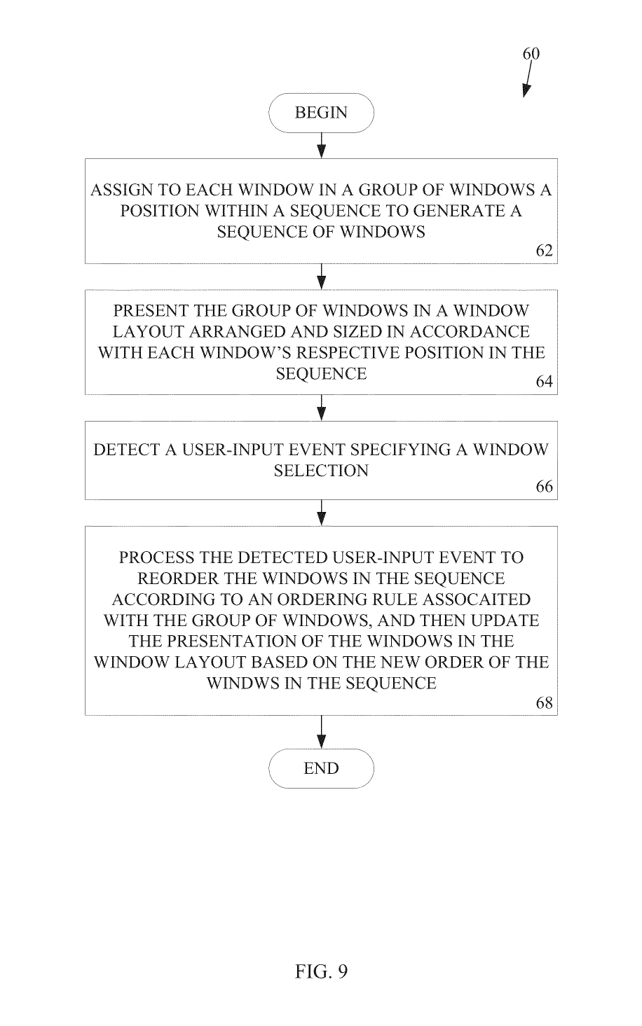

FIG. 9 is a flow diagram illustrating an example method 60 for managing the presentation of a group of windows, according to some embodiments of the invention. The method begins at method operation 62 when each window in a group of windows is assigned a position in a sequence. For instance, with some embodiments, this operation may involve assigning a number to each window, such that the number indicates the order of the windows in an ordered list or mathematical sequence. The initial order of the windows in the sequence may be based on a user-specified configuration setting for the group of windows. For instance, a user may have previously established a desired order in which the windows should be arranged when first presented. Alternatively, the initial arrangement or ordering of the windows may be determined based on an ordering rule, as described above.

Next, at method operation 64, the group of windows are presented in a window layout arranged and sized in accordance with each window's respective position in the sequence, or ordered list. For instance, consistent with some embodiments, a window manager, operating in conjunction with a windowing system, will manipulate the graphical user interface that is presented on a display device to show each window in the group of windows arranged according to a particular window layout (examples of which are shown in FIGS. 1 through 6). With some embodiments, the window associated with the first position in the sequence (referred to herein as a primary windows) will be prominently positioned and sized larger than the other windows in the window layout. Each successive window in the sequence will be sized in accordance with a sizing ratio, that will ultimately size the windows in relationship with one another to optimally present the windows in the available display space.

At method operation 66, a user-input event is detected. For example, a user may submit a command using one of any number of user-input mechanisms and techniques. The operating system or windowing system, upon detecting the event associated with the user-issued command, will forward the command to the window manager for processing, or will otherwise direct the window manager to manipulate the window layout in accordance with the user-issued command. At least in some embodiments, the command, and thus the detected event, will specify or identify a window and a window layout. For example, the command may identify a particular window to be shown in a full screen window layout. The command may specify that a particular window is to become the new primary window in an existing window layout. Finally, the command may specify that a window is to shown in a side-by-side window layout with the current primary window. Of course, the command may specify other window layouts as well.

Finally, at method operation 68, the user-input event, associated with the user-issued command, is processed to reorder the windows in accordance with an ordering rule that is associated with the group of windows. In addition, the presentation of the windows is updated so that the windows are presented, sized and arranged, in accordance with their new positions in the window sequence.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, objects or devices that operate to perform one or more operations or functions. The modules, objects and devices referred to herein may, in some example embodiments, comprise processor-implemented modules, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

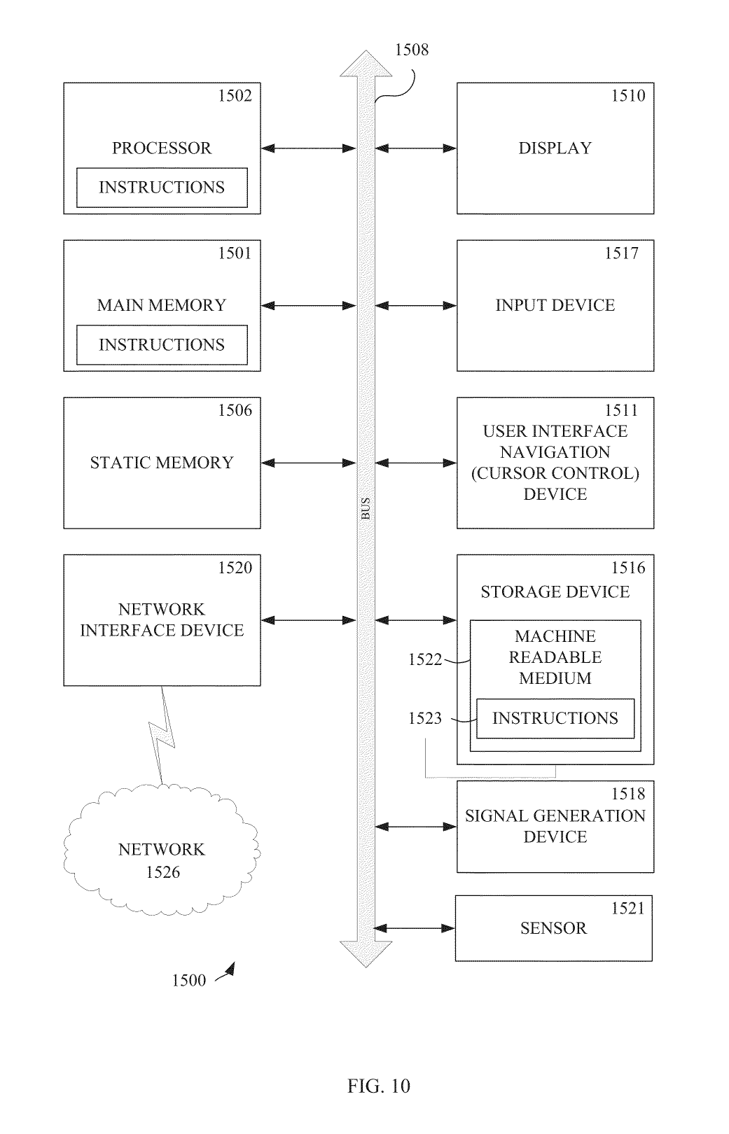

FIG. 10 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method for managing the presentation of windows, the method comprising:
assigning to each window in a group of windows an initial position in an initial sequence;
causing display, on a display device, of the group of windows arranged in accordance with a window layout, the position of each window in the window layout based on the position of the window in the initial sequence, wherein the window in the first position of the initial sequence is sized based on the size of the display, and wherein each subsequent window in the initial sequence is sized based on a sizing ratio that sizes each subsequent window smaller than a preceding window in the initial sequence;
responsive to detecting a user-input event, rearranging the positions of the windows in the initial sequence in accordance with an ordering rule associated with the group of windows to generate a reordered sequence; and
causing display, on the display device, of the group of windows arranged in accordance with the window layout, the position of each window in the window layout based on the reordered sequence, wherein the window in the first position of the reordered sequence is re-sized based on the size of the display, and wherein each subsequent window in the reordered sequence is re-sized based on a sizing ratio that sizes each subsequent window smaller than a preceding window in the initial sequence.

2. (canceled)

3. The method of claim 1, wherein the window layout specifies that the windows are to be positioned relative to one another to form a spiral, such that a curved line connecting the opposite corners of the windows forms a Fibonacci spiral.

4. The method of claim 1, wherein the initial position in the sequence assigned to each window is determined based on one of the following: a user-specified configuration setting for the group of windows; a default rule or position; and, the ordering rule associated with the group of windows.

5. The method of claim 1, wherein the ordering rule is based on a most-recently-used algorithm, the user-input event specifies a window in the group of windows to replace a primary window in the window layout, and rearranging the positions of the windows in the sequence to generate a reordered sequence includes:
assigning the window specified in the user-input event the first position the sequence, and shifting the positions of all other windows in the sequence, as necessary, by increasing a number representing a window's position by one.

6. The method of claim 1, wherein the ordering rule is based on a most-frequently-used algorithm, the user-input event specifies a window in the group of windows to replace a primary window in the window layout, the primary window corresponding with the window assigned the first position in the sequence, and rearranging the positions of the windows in the sequence to generate a reordered sequence includes:
assigning the window specified in the user-input event the first position in the sequence, and assigning all other windows in the group of windows a position in the sequence based on a measure of how frequently each respective window is used, such that the windows are ordered based on their respective frequency of use.

7. The method of claim 1, wherein the ordering rule is based on a cycling algorithm, the user-input event specifies a window in the group of windows to replace a primary window in the window layout, the primary window corresponding with the window assigned the first position in the sequence, and rearranging the positions of the windows in the sequence to generate a reordered sequence includes:
assigning the window specified in the user-input event the first position in the sequence, and assigning the former first-positioned window the last position in the sequence.

8. The method of claim 1, further comprising:
responsive to detecting a second user-input event specifying a window in the group of windows, presenting on the display device in a side-by-side window layout a primary window corresponding with the window first in the sequence, and the window specified in the user-input event.

9. The method of claim 1, further comprising:
responsive to detecting a second user-input event specifying a window in the group of windows, presenting the window specified in the event in a full screen window layout.

10. A computing device comprising:
a memory storing executable instructions thereon, which, when executed by a processor of the computing device, cause the computing device to:
assign to each window in a group of windows an initial position in an initial sequence;
cause displaying, on a display device, of the group of windows arranged in accordance with a window layout, the position of each window in the window layout based on the position of the window in the initial sequence, wherein the window in the first position of the initial sequence is sized based on the size of the display, and wherein each subsequent window in the initial sequence is sized based on a sizing ratio that sizes each subsequent window smaller than a preceding window in the initial sequence;
responsive to detecting a user-input event, rearrange the positions of the windows in the initial sequence in accordance with an ordering rule associated with the group of windows to generate a reordered sequence; and
cause displaying, on the display device, of the group of windows arranged in accordance with the window layout, the position of each window in the window layout determined based on the reordered sequence, wherein the window in the first position of the reordered sequence is re-sized based on the size of the display, and wherein each subsequent window in the reordered sequence is re-sized based on a sizing ratio that sizes each subsequent window smaller than a preceding window in the initial sequence.

11. (canceled)

12. The computing device of claim 10, wherein the window layout specifies that the windows are to be positioned relative to one another to form a spiral, such that a curved line connecting the opposite corners of the windows forms a Fibonacci spiral.

13. The computing device of claim 10, wherein the initial position in the sequence assigned to each window is determined based on one of the following: a user-specified configuration setting for the group of windows; a default rule or position; and, the ordering rule associated with the group of windows.

14. The computing device of claim 10, wherein the ordering rule is based on a most-recently-used algorithm, the user-input event specifies a window in the group of windows to replace a primary window in the window layout, and comprising further instructions, which, when executed by the processor of the computing device, cause the computing device to:
assign the window specified in the user-input event the first position in the sequence, and shift the positions of all other windows in the sequence, as necessary, by increasing a number representing a window's position by one.

15. The computing device of claim 10, wherein the ordering rule is based on a most-frequently-used algorithm, the user-input event specifies a window in the group of windows to replace a primary window in the window layout, the primary window corresponding with the window assigned the first position in the sequence, and comprising further instructions, which, when executed by the processor of the computing device, cause the computing device to:
assign the window specified in the user-input event the first position in the sequence, and assign all other windows in the group of windows a position in the sequence based on a measure of how frequently each respective window is used, such that the windows are ordered based on their respective frequency of use.

16. The computing device of claim 10, wherein the ordering rule is based on a cycling algorithm, the user-input event specifies a window in the group of windows to replace a primary window in the window layout, the primary window corresponding with the window assigned the first position in the sequence, and comprising further instructions, which, when executed by the processor of the computing device, cause the computing device to:
assign the window specified in the user-input event the first position in the sequence, and assign the former first-positioned window the last position in the sequence.

17. The computing device of claim 10, wherein each window in the group of windows is assigned a priority value and the ordering rule is based on a highest (priority algorithm, the user-input event specifying that the primary window is to be closed, minimized, or dismissed, and comprising further instructions, which, when executed by the processor of the computing device, cause the computing device to:
rearrange the order of windows in the sequence of windows based on their respective assigned priority values, such that the secondary window with the highest (priority value becomes the first window in the sequence of windows, and thus becomes the primary window.

18. The computing device of claim 17, wherein the priority values assigned to the windows in the group of windows are determined algorithmically and can dynamically change based upon detection of various events and/or conditions.

19. The computing device of claim 10, comprising further instructions, which, when executed by the processor of the computing device, cause the computing device to:
detect a second user-input event specifying a window in the group of windows; and
present on the display device in a side-by-side window layout a primary window corresponding with the window first in the sequence, and the window specified in the user-input event.

20. The computing device of claim 10, comprising further instructions, which, when executed by the processor of the computing device, cause the computing device to:
detect a second user-input event specifying a window in the group of windows; and
present the window specified in the event in a full screen window layout.

21. A non-transitory computer readable storage medium storing instructions thereon, which, when executed by a processor of a computing device, cause the computing device to:
assign to each window in a group of windows an initial position in an initial sequence;
cause displaying, on a display device, of the group of windows arranged in accordance with a window layout, the position of each window in the window layout determined based on the position of the window in the initial sequence, wherein the window in the first position of the initial sequence is sized based on the size of the display, and wherein each subsequent window in the initial sequence is size based on a sizing ratio that sizes each subsequent window smaller than a preceding window in the initial sequence;
responsive to detecting a user-input event, rearrange the positions of the windows in the sequence in accordance with an ordering rule associated with the group of windows to generate a reordered sequence; and
cause displaying, on the display device, of the group of windows arranged in accordance with the window layout, the position of each window in the window layout determined based on the reordered sequence, wherein the window in the first position of the reordered sequence is re-sized based on the size of the display, and wherein each subsequent window in the reordered sequence is re-sized based on a sizing ratio that sizes each subsequent window smaller than a preceding window in the initial sequence.
